(19) United States
(12) Patent Application Publication
(10) Pub. No.: US 2017/0067807 A1
(43) Pub. Date: Mar. 9, 2017

(54) SEPARATION AND ASSAY OF TARGET ENTITIES USING FILTRATION MEMBRANES COMPRISING A PERFORATED TWO-DIMENSIONAL MATERIAL

(71) Applicant: LOCKHEED MARTIN CORPORATION, Bethesda, MD (US)

(72) Inventors: Sarah SIMON, Baltimore, MD (US); John B. STETSON, New Hope, PA (US)

(73) Assignee: LOCKHEED MARTIN CORPORATION, Bethesda, MD (US)

(21) Appl. No.: 15/308,351

(22) PCT Filed: May 1, 2015
(86) PCT No.: PCT/US15/28948

§ 371 Date: Nov. 1, 2016

Related U.S. Application Data
(63) Continuation-in-part of application No. 14/193,007, filed on Feb. 28, 2014.
(60) Provisional application No. 61/987,410, filed on May 1, 2014.

(30) Foreign Application Priority Data
Feb. 27, 2015 (US) PCT/US2015/018114

(51) Int. Cl. G01N 1/40; B01D 71/02; B01D 61/02

(52) U.S. Cl. CPC G01N 1/4077; B01D 61/027; B01D 71/021; G01N 2001/4088; B01D 2319/02; B01D 2325/02

(57) ABSTRACT

Perforated graphene and other perforated two-dimensional materials can be used to sequester target entities having a particular range of sizes or chemical characteristics. The target entities sequestered thereon can be further assayed for quantification/qualification purposes. Use of multiple filter membranes can allow particular size ranges or chemical characteristics of target entities to be isolated and further analyzed. Methods for assaying a target entity, particularly a biological target entity, can include providing one or more filter membranes disposed in series with one another, the filter membranes containing a perforated two-dimensional material, and the filter membranes having an effective pore size that decreases in a direction of intended fluid flow; and passing a fluid through the filter membranes. The methods can also include assaying for at least one target entity on the filter membranes.

### CROSS-REFERENCE TO RELATED APPLICATIONS

This application claims the benefit of priority to U.S. Provisional Application No. 61/987,410 filed May 1, 2014 and to International Application No. PCT/US2015/18114, filed Feb. 27, 2015, which in turn claims the benefit of U.S. application Ser. No. 14/193,007, filed Feb. 28, 2014. Each of these applications is incorporated by reference herein in its entirety.

### BACKGROUND

The present disclosure generally relates to devices configured for withdrawal and/or dispensation of a fluid, particularly a medical fluid, and analysis thereof, and, more specifically, to syringes and other devices employing one or more two-dimensional separation membrane and methods for use thereof in separating and assaying for target entities of various sizes or chemical activities. Devices herein include those which can capture sub-micron materials, including nanosized materials from a fluid. Devices herein can function to selectively collect target entities within one or more predetermined range of sizes. These predetermined size ranges may be representative of certain entity types, biological cells (protozoa, fungi, bacteria, mammalian cells, tumor cells), viruses (retrovirus, enveloped virus), biological molecules (e.g., proteins, polypeptides, nucleic acids, polysaccharides, peptide toxins), small molecules (e.g., drugs, chemical toxins), atomic species (e.g., halide ions, metal ions). Target entities collected by size range can be subjected to one or more assays appropriate for the type and size of entity collected.

When performing various types of assays, it can often be desirable to separate components based upon their size and/or chemical characteristics (e.g., charge state, ability to bind or otherwise interact with another chemical or biological species, etc.). At the macroscale, separation can be accomplished via a number of techniques. In contrast, at the nanometer or molecular size scale (about 1000 nanometers to 0.5 nm, particularly 500 nm to 1 nm) separation can become much more difficult. Particularly, it can be difficult to develop separation membranes with apertures that provide sufficient resolution to allow passage of smaller molecules in deference to larger ones or separation of a subset of molecules having a target size from a plurality of molecules having sizes above and below the target size. Target entities (also referred to herein as analytes) that are smaller than the occlusion size of a separation membrane can sometimes result in interference in an analysis, particularly when analyzing biological materials, if they pass through a membrane being used for conducting a separation process. Benefits to efficiency and selectivity in analysis can be obtained when target entities are separated by size range prior to assay, in that assays appropriate for target entities of a particular size range, e.g., biological cells, can be more selectively applied.

Although there are a number of fields in which separation on a molecular scale can be desirable, various medical applications and other separations of biological materials can benefit from separation and analysis of target entities with different molecular sizes, particularly various biological molecules such, for example, viruses, bacteria, protozoa, fungi, proteins, antibodies, peptides, nucleic acids (DNA, RNA) and the like. Various toxins that may be hazardous to biological life forms can also be desirable for separation and analysis. These materials come in a variety of sizes and shapes and have varying chemical characteristics.

Currently, it can be very difficult to separate and analyze various target entities from one another based upon their molecular size or chemical characteristics, such as biological molecules or other target entities from a blood sample or other biological fluid, thereby allowing informed decisions to be made therefrom (e.g., a proposed course of treatment). Although current medical testing techniques can often be effective, they are often highly specific and require a number of individual devices and strategies to perform the testing. As a result, current medical testing techniques can often be fairly slow and only provide input on particular types of molecular entities. Further, they can also be subject to interference from non-target entities present in biological fluids.

In view of the foregoing, methods for separating and assaying various target entities from a fluid, particularly biological molecules from a biological or medical fluid would be of considerable benefit in the art. More particularly, devices and methods for separating and assaying target entities of a particular size or having a specific chemical characteristic from a fluid and non-target entities, particularly separation from a biological medium, would be of considerable benefit in the art. The further ability to separate a plurality of target entities of different sizes in a given fluid according to a plurality of size ranges to allow selective assay of such size-separated target entities would be of additional benefit in the art. In some circumstances, combination of such size separations with methods of withdrawal of fluid samples, for example where the separation device is implemented in a syringe or other sampling mechanism would provide additional benefit. The present disclosure satisfies the foregoing needs and provides related advantages as well.

### SUMMARY

The present disclosure describes filtration device configurations and methods for separating and assaying target entities having different sizes and/or chemical characteristics from one another. In some embodiments, filtration device configurations include one or more filter membranes (also called separation membranes) disposed is series with one another where the filter membrane contain perforated two-dimensional material and wherein the filter membranes have an effective pore size that decreases in a directed of intended fluid flow. In specific embodiments, filtration device configurations include more than two filter membranes which function for size separation and which in combination separate entities in the fluid (including target entities) into one, or preferably more than one, size-range-selected pools of entities (including one or more target entities).

In some embodiments, the methods can include providing one or more filter membranes disposed in series with one another, where the filter membranes contain a perforated two-dimensional material and the filter membranes have an effective pore size that decreases in a direction of intended fluid flow; passing a fluid through the filter membranes; and optionally assaying for at least one target entity sequestered by the filter membranes. Assaying can take place while the at least one target entity is sequestered on the filter membranes or after it has been released therefrom. In a related embodiment, the sequestered at least one target entity can be selectively subjected to alteration which results in product entities thereof which product entities can be subject to subsequent size-separation and/or subject to one or more appropriate assays.

In a more specific embodiment, more than two filtration membranes are disposed in series where effective pore size of a filter decreases in a direction of fluid flow where the filter membranes function in combination to separate or sequester a plurality of entities in the fluid into size-range-selected pools of entities (including one or more target entities). One or more assays can be applied to one or more of the size-selected pools of entities. Assays can be performed while the at least one target entity is sequestered on the filter membranes or after an entity has been released therefrom.

The present disclosure also describes methods for administering a fluid to a patient. In various embodiments, the methods can include providing at least one filter membrane containing a perforated two-dimensional material, and administering a fluid to a patient after passing the fluid through the at least one filter membrane, where the at least one filter membrane removes at least one biological material or toxin from the fluid.

The foregoing has outlined rather broadly the features of the present disclosure in order that the detailed description that follows can be better understood. Additional features and advantages of the disclosure will be described hereinafter. These and other advantages and features will become more apparent from the following description.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1A shows an illustrative schematic of a syringe containing a standard interface to which a filter membrane can be attached; FIG. 1B shows an illustrative schematic of a syringe having a removable filter membrane containing a perforated two-dimensional material attached thereto;

FIGS. 2A-2C show illustrative schematics of filter membranes containing a perforated two-dimensional material disposed between two layers of a support;

FIGS. 3 and 3B show illustrative schematics of a graphene-based filter membrane disposed in a luer-lock housing;

FIG. 4 shows an illustrative schematic of graphene-based filter membranes disposed in series, where the pore size can be the same or different;

FIG. 5 shows an illustrative schematic of a plurality of filter membranes arranged in series, where the effective pore size decreases in the direction of intended fluid flow;

FIG. 6 shows a schematic illustrating the effect of decreasing pore size, where progressively smaller molecular entities are occluded within the filter;

FIG. 7 shows an illustrative schematic wherein the filter membrane configuration of FIG. 5 can be stimulated by an electrical current to promote release and analysis of the target entities occluded therein; and

FIG. 8 shows an illustrative schematic of a series of filter membranes stacked together to sequester biological entities of different effective sizes.

### DETAILED DESCRIPTION

The present disclosure is directed, in part, to devices containing one or more filter membranes containing a two-dimensional material. The present disclosure is also directed, in part, to methods for separating and optionally assaying target entities having a defined size or chemical characteristic from a fluid medium, particularly a biological fluid, using one or more filter membranes, where the filter membranes are each configured to separate target entities having a defined size or chemical characteristic.

Graphene has garnered widespread interest for use in a number of applications due to its favorable mechanical and electronic properties. Graphene represents an atomically thin layer of carbon in which the carbon atoms reside as closely spaced atoms at regular lattice positions. The regular lattice positions can have a plurality of defects present therein, which can occur natively or be intentionally introduced to the graphene basal plane. Such defects will also be equivalently referred to herein as “apertures,” “perforations,” or “holes.” The term “perforated graphene” will be used herein to denote a graphene sheet with defects in its basal plane, regardless of whether the defects are natively present or intentionally produced. Aside from such apertures, graphene and other two-dimensional materials can represent an impermeable layer to many substances. Therefore, if they can be sized properly, the apertures in the impermeable layer can be useful retaining target entities that are larger than the effective pore size. In this regard, a number of techniques have been developed for introducing a plurality of perforations in graphene and other two-dimensional materials, where the perforations have a desired size, number and chemistry about the perimeter of the perforations. Chemical modification of the apertures can allow target entities having particular chemical characteristics to be preferentially retained or rejected as well.

The invention employs filtration membranes which comprise perforated two-dimensional materials with a plurality of apertures to effect separation of sub-micron or nanosized components. Various two-dimensional materials useful in the present invention are known in the art. In various embodiments, the two-dimensional material comprises graphene, molybdenum sulfide, or boron nitride. In an embodiment, the two-dimensional material is a graphene-based material. In more particular embodiments, the two-dimensional material is graphene. Graphene, according to the embodiments of the present disclosure, can include single-layer graphene, multi-layer graphene, or any combination thereof. Other nanomaterials having an extended two-dimensional molecular structure can also constitute the two-dimensional material in the various embodiments of the present disclosure. For example, molybdenum sulfide is a representative chalcogenide having a two-dimensional molecular structure, and other various chalcogenides can constitute the two-dimensional material in the embodiments of the present disclosure. Choice of a suitable two-dimensional material for a particular application can be determined by a number of factors, including the chemical and physical environment into which the graphene or other two-dimensional material is to be terminally deployed.

In an embodiment, the two dimensional material useful in membranes herein is a sheet of graphene-based material. Graphene-based materials include, but are not limited to, single layer graphene, multilayer graphene or interconnected single or multilayer graphene domains and combinations thereof. In an embodiment, graphene-based materials also include materials which have been formed by stacking single or multilayer graphene sheets. In embodiments, multilayer graphene includes 2 to 20 layers, 2 to 10 layers or 2 to 5 layers. In embodiments, graphene is the dominant material in a graphene-based material. For example, a graphene-based material comprises at least 30% graphene, or at least 40% graphene, or at least 50% graphene, or at least 60% graphene, or at least 70% graphene, or at least 80% graphene, or at least 90% graphene, or at least 95% graphene. In embodiments, a graphene-based material comprises a range of graphene selected from 30% to 95%, or from 40% to 80% from 50% to 70%, from 60% to 95% or from 75% to 100%.

As used herein, a “domain” refers to a region of a material where atoms are uniformly ordered into a crystal lattice. A domain is uniform within its boundaries, but different from a neighboring region. For example, a single crystalline material has a single domain of ordered atoms. In an embodiment, at least some of the graphene domains are nanocrystals, having domain size from 1 to 100 nm or 10-100 nm. In an embodiment, at least some of the graphene domains have a domain size greater than 100 nm to 1 micron, or from 200 nm to 800 nm, or from 300 nm to 500 nm. “Grain boundaries” formed by crystallographic defects at edges of each domain differentiate between neighboring crystal lattices. In some embodiments, a first crystal lattice may be rotated relative to a second crystal lattice, by rotation about an axis perpendicular to the plane of a sheet, such that the two lattices differ in “crystal lattice orientation”.

In an embodiment, the sheet of graphene-based material comprises a sheet of single or multilayer graphene or a combination thereof. In an embodiment, the sheet of graphene-based material is a sheet of single or multilayer graphene or a combination thereof. In another embodiment, the sheet of graphene-based material is a sheet comprising a plurality of interconnected single or multilayer graphene domains. In an embodiment, the interconnected domains are covalently bonded together to form the sheet. When the domains in a sheet differ in crystal lattice orientation, the sheet is polycrystalline.

In embodiments, the thickness of the sheet of graphene-based material is from 0.34 to 10 nm, from 0.34 to 5 nm, or from 0.34 to 3 nm. In an embodiment, a sheet of graphene-based material comprises intrinsic defects. Intrinsic defects are those resulting from preparation of the graphene-based material in contrast to perforations which are selectively introduced into a sheet of graphene-based material or a sheet of graphene. Such intrinsic defects include, but are not limited to, lattice anomalies, pores, tears, cracks or wrinkles. Lattice anomalies can include, but are not limited to, carbon rings with other than 6 members (e.g. 5, 7 or 9 membered rings), vacancies, interstitial defects (including incorporation of non-carbon atoms in the lattice), and grain boundaries.

In an embodiment, membrane or membrane portions comprising the sheet of graphene-based material further comprises non-graphenic carbon-based material located on the surface of the sheet of graphene-based material. In an embodiment, the non-graphenic carbon-based material does not possess long range order and may be classified as amorphous. In embodiments, the non-graphenic carbon-based material further comprises elements other than carbon and/or hydrocarbons. Non-carbon elements which may be incorporated in the non-graphenic carbon include, but are not limited to, hydrogen, oxygen, silicon, copper and iron. In embodiments, the non-graphenic carbon-based material comprises hydrocarbons. In embodiments, carbon is the dominant material in non-graphenic carbon-based material. For example, a non-graphenic carbon-based material comprises at least 30% carbon, or at least 40% carbon, or at least 50% carbon, or at least 60% carbon, or at least 70% carbon, or at least 80% carbon, or at least 90% carbon, or at least 95% carbon. In embodiments, a non-graphenic carbon-based material comprises a range of carbon selected from 30% to 95%, or from 40% to 80%, or from 50% to 70%.

Two-dimensional materials in which pores are intentionally created are referred to herein as “perforated”, such as “perforated graphene-based materials”, “perforated two-dimensional materials’ or “perforated graphene.” The present disclosure is also directed, in part, to perforated graphene, perforated graphene-based materials and other perforated two-dimensional materials containing a plurality of apertures (or holes) ranging from about 5 to about 1000 angstroms in size. In a further embodiment, the hole size ranges from 100 nm up to 1000 nm or from 100 nm to 500 nm. The present disclosure is further directed, in part, to perforated graphene, perforated graphene-based materials and other perforated two-dimensional materials containing a plurality of holes ranging from about 5 to 1000 angstrom in size and having a narrow size distribution, including but not limited to a 1-10% deviation in size or a 1-20% deviation in size. In an embodiment, the characteristic dimension of the holes is from 5 to 1000 angstrom. For circular holes, the characteristic dimension is the diameter of the hole. In embodiments relevant to non-circular pores, the characteristic dimension can be taken as the largest distance spanning the hole, the smallest distance spanning the hole, the average of the largest and smallest distance spanning the hole, or an equivalent diameter based on the in-plane area of the pore. As used herein, perforated graphene-based materials include materials in which non-carbon atoms have been incorporated at the edges of the pores.

As discussed above, separation of various target entities can be desirable in a number of instances, particularly in biological separation processes.

Such separation can be achieved employing a filter device having one or more or preferably more than two filter membranes disposed in series with one another, the filter membranes are spaced apart from each other, and the filter membranes having selected effective pore size that decreases in a direction of intended fluid flow wherein effective pore sizes of filters are selected to provide for separation of fluid components into pre-determined size-range pools. The filter membrane are spaced apart such that entities of a given size that pass through the pores of a preceding membrane or membranes are trapped or sequestered on a following membrane having pores sized such that the entities do not pass there through. In an embodiment, each filter membrane comprises perforated two-dimensional material which functions for size selection. Spacing apart of the filter membrane can provide a space or enclosure for containment of entities sequestered on a filter after separation from fluid. This space or enclosure can be accessed generally for collection, analysis and/or identification of the sequestered entities, for example for collection of all or part of the sequestered entities, for introduction of light (of selected wavelength or wavelength range) to conduct an assay, for introduction of reagents or other materials for conducting an assay, or for observation of a change in color, wavelength of light introduced or other indicator associated with an assay. In an embodiment, the space or enclosure can be accessed to modify one or more entities sequestered therein. Modification can include among others, reaction or interaction with a reagent or other added chemical or biological molecule, irradiation to break one or more bonds, release or braking of a bond by introduction of a reactant, introduction of light of selected wavelength, introduction of a ligand or antibody to bind to one or more entities sequestered. In a specific embodiment, modification relates to application of an electrically current to one or more filter membranes.

In an embodiment, each filter membrane comprises perforated two dimensional material which is functionalized and wherein the filter membrane functions for separation by size and/or chemical characteristic. Functionalization includes functionalization in the vicinity of pores and/or functionalization on other portions of the filter membrane. Functionalization of filter pores can be accomplished by any means known in the art. Functionalization includes functionalization to attach carboxylate or related acidic or negatively charged chemical species or to attach amine or related basic or positively charged chemical species. Additional functionalization can include functionalization with hydrophobic groups or functionalization with hydrophilic groups where various such groups are known in the art. Additional functionalization can include functionalization with polar groups or functionalization with non-polar groups where various such groups are known in the art. Additional functionalization includes borate, sulfate, sulfoxide, and organosilanes among others. Functionalization can include functionalization with organic polymers or biological polymers. Functionalization includes functionalization to attach a protein receptor, a ligand, an antibody, or other chemical or biological species which selectively binds to one or more target entities. Functionalization is typically attached to the filter membrane or pores therein via a linking species which spaces the functionalization from the filter surface. Various linkers are known in the art and include hydrocarbon linkers, ether linkers, thioether linkers. For example a linker may contain a plurality of —CH₂— moieties in combination with one or more —O—, —S—, —CO—, —COO—, —NH—, —NH—CO—. Exemplary linkers can contain 2-50 carbon atoms and 2-20 heteroatoms selected from oxygen, nitrogen and sulfur.

Exemplary useful size-range pools include (1) those that separate intact cells from the remains of disrupted cells (e.g., cell organelles, cell parts or cell components) or biological molecules contained in cells (e.g., nucleic acids, proteins, protein aggregates) or small molecules such as drugs or toxins; (2) those that separate different sizes of biological molecules (e.g., different size proteins, different size nucleic acids, different sizes of carbohydrates); (3) those that separate polymeric biological molecules (proteins, nucleic acids, polysaccharides) from non-polymeric biological molecules such as amino acids, small peptides, nucleotide, nucleosides, small nucleic acids (e.g., having 2-20 bases), monosaccharide, disaccharides or the like; (4) those that separate polymeric biological molecules from small molecules such as drugs or non-peptide toxins; or (5) those that separate protein receptors from ligands that potentially bind to such receptors. It will be apparent to one of ordinary skill in the art that many other size range pools may be useful to provide.

In specific embodiments, size-range pools include one or more pools containing entities ranging in size as follows: above 1000 nm; below 1000 nm, above 500 nm, below 500 nm, above 100 nm, below 100 nm, above 50 nm, below 50 nm, above 20 nm, below 20 nm, above 10 nm, below 10 nm, above 5 nm, below 5 nm, below 1 nm, between 1000 and 500 nm, between 500 and 100 nm, between 100 and 20 nm, between 20 nm and 10 nm, between 20 nm and 5 nm, between 5 nm and 1 nm, between 7-15 nm. In specific embodiments, the range above 1000 nm or above 500 nm can be employed to capture biological cells. In specific embodiments, the range above 20 nm, the range between 100 and 20 nm or the range between 50 and 20 nm can be used to capture viruses. In specific embodiments, the range below 20 or between 4-20 nm can be used to capture proteins. Effective pores sizes of filter membranes can be selected to provide for separation into such exemplary size-range pools. It will be apparent to one of ordinary skill in the art that many other size range pools may be of interest and can be provides by appropriate choice of effective pore sizes.

In specific embodiments, a filter device comprises a plurality of filter modules disposed in fluid communication and in series with one another along a direction of intended fluid flow wherein each filter module comprises a perforated two-dimensional material and a filter housing for holding the perforated two-dimensional material in place wherein the effective pore size of the perforated two dimension material of the serially disposed modules decrease in the direction of intended flow. In specific embodiments, the filter housings are configured for serial engaging or interfacing with adjacent filter housing to form a seal there between to prevent leakage of fluid when fluid is passaged through the filter device. In specific embodiments, each filter module is provided with an optionally valved inlet and an optionally valved outlet to facilitate fluid flow through the device. Valved inlets and outlets can be selectively opened or closed as desired. Closing of inlet and outlet valves in a module can be employed to isolate entities therein from those in other modules. In specific embodiments, the filter device includes a first and last filter module and intervening filter modules wherein the first module is provided with an optionally valved fluid inlet to facilitate fluid flow through the device and wherein the last module (with smallest pore size) is provided with an optionally valved fluid outlet.

Inlets and outlets herein are optionally valved to allow for selective opening and closing thereof. Actuation of such valves can be by any known meaning and can be automated as known in the art and the opening and closing of selected valves can be optionally synchronized as known in the art. Inlets and outlets herein can optionally be provided as one-way valves, for example, to implement fluid flow (or predominant fluid flow) in one selected direction.

At least one filter module of the filter device optionally further comprises an access port providing access to entities collected on the filter membrane. In an embodiment, the access port is positioned such that it is not in the intended direction of fluid flow though the device. In an embodiment, the access port opening is perpendicular to the intended direction of fluid flow through the device. The access port can be used for removal or addition to the filter module. The access port can be employed for removal of all or part of one or more target entities on the filter membrane. The access port can be employed for addition of light, particularly light of selected wavelength, e.g., UV-VIS, for example for modification or assay of one or more target entities. The access port can be employed for observing a color change, for collecting light and measuring wavelength and/or intensity, for collecting entitles sequestered on the filter membrane or products generated from entities.

At least one filter module of the filter device further comprises a chamber formed adjacent to the filter membrane and in which entitles collected on the filter membrane can be enclosed. Such chamber must provide for fluid flow through the device in the intended direction of fluid flow and as such is optionally provided with optionally valved fluid inlet and outlet. The chamber can however be formed between two adjacent filter modules which interface with each other via a connector or seal that prevents fluid leakage.

A filter module can be provided with an optionally valved cross-flow inlet and/or an optionally valved cross-flow outlet. Such inlet or outlet can allow cross-flow of a fluid, such as a wash flow, other than the fluid from which target entities are to be separated or sequestered. Operation of a cross-flow outlet can be employed to selectively divert fluid flow from passage through subsequent filter modules disposed in the device. Coordinated operation of a cross-flow inlet and outlet can be used to flow a fluid through the folder and transverse to the filter membrane for example, to release entities including target entities from the surface of the membrane. The cross-flow can also be employed to introduce one or more selected reagents or reactants to the filter module to facilitate assay of the entities including target entities sequestered on the surface of the membrane. The flow emanating from the cross-flow outlet can be directed to a reservoir or other container for collection, disposal or additional processing as desired. The flow emanating from the cross-flow outlet, for example, be directed into another filter module of the device or into a separate filtration device, or into an analytical instrument (i.e., Gas chromatograph (GC), mass spectrometer (MS) or GC/MS for analysis or further analysis. The fluid exiting the filtration device can be directed to a reservoir or other container for collection, disposal or further processing as desired or the exiting fluid can be directed to an analytical instrument for separation and/or analysis.

In specific embodiments, the effective pore size of the filter membranes ranges in size from 0.5 nm to 1000 nm. In other specific embodiments, the effective pore size of the filter membranes range from 0.5 to 500 nm or from 0.5 to 100 nm or from 0.5 to 50 nm, or from 0.5 to 20 nm.

In an embodiment, a filter module of the filtration device is removable or replaceable with another filter module. In an embodiment, the number of filtration modules in the filtration device can be selectively changed by removal of one or more selected modules or by addition or one or more additional modules. Thus, the size-ranges that a given filter device can separate can be adjusted by addition or subtraction of one or more filter modules. In an embodiment, a filtration device can be provided with a set of filter modules to provide a first set of pre-determined size-range separations and be modified by addition or subtraction of one or more filter modules for selected size ranges not in said first set to provide a second set of pre-determined size-range separations. The modular configuration of the filter device provide for significant flexibility in sculpting the size ranges that are to be separated in to size range pools.

In a specific embodiment, one or more assays are conducted in one or more filter modules of the filter device. In a specific embodiment, one or more colorimetric assays are conducted in one or more filter modules of the invention. In an embodiment, the housing of one or more filter modules in the filter device is transparent to allow observation of a color change associated with an assay. Various colorimetric assays (where a color change identifies a characteristic of one or more target entities) are known in the art an can be readily adapted for use in the devices and methods herein.

In a specific embodiment, the filter device of the invention is implemented in a syringe configuration. In such a configuration, a luer lock fitting as an inlet for fluid flow in the intended direction can be employed. In such a configuration, in the alternative, a fluid contained in a syringe barrel can be employed to provide fluid flow through the filter device. In syringe embodiments, fluid can be drawn into the filter device by operation of the syringe plunger. Alternatively, fluid drawn into a syringe barrel can thereafter be pushed through the filter device by operation of the syringe plunger.

International application PCT/US2015/18114, filed Feb. 27, 2015, and U.S. application Ser. No. 14/193,007, filed Feb. 28, 2014, contain addition description for implementation of a syringe embodiment adapted to a filtration device of this invention. It is noted that filtration devices of this invention can in an embodiment, be implemented employing filter cartridges as described in these patent documents. Each of these patent documents is incorporated by reference herein in its entirety for descriptions of syringes and their operation, for descriptions of certain filter cartridges and for description for certain filtration applications.

A syringe equipped with a replaceable filter cartridge containing graphene, for example, can be used in separating target entities with a particular size range or certain chemical characteristics. Other perforated two-dimensional materials may be used in a similar manner. The filter cartridge can be interchangeable with filtration membranes of different perforation sizes and/or chemistries, such that a desired separation process can take place.

In an embodiment, the syringes and filter module or cartridge described in the above size-based application, a filter membrane with a first perforation size is inserted into the syringe and a fluid is drawn into the syringe body, such that target entities larger than the first perforation size are rejected on the membrane. For example, a specimen of blood plasma can be withdrawn such that target entities smaller than the first perforation size are drawn into the syringe body. Thereafter, the filter membrane can be switched with a filter membrane having a second perforation size that is smaller than the first perforation size. Emptying the syringe then rejects target entities on the filter membrane that are smaller than the second perforation size and molecular entities between the first perforation size and the second perforation size are dispensed for analysis. Alternately, the fluid drawn into the syringe can be analyzed further without undergoing a subsequent separation process (e.g., without being dispensed through the filter membrane having the second perforation size), although this approach has the potential for interference from smaller target entities that would have otherwise been removed with the second filter membrane. If desired, further separation of the fluid can take place before analyzing for a particular component. For example, viruses can be separated from the dispensed fluid by conventional biological separation techniques, and the remaining components can then undergo analysis, such as specific quantitative or qualitative protein analyses. Any number of biological entities such as, for example, bacteria, viruses, protozoa, proteins, antibodies, and the like can be assayed through the techniques described herein.

As used herein, an assay is an investigative/analytical procedure in laboratory medicine, pharmacology, environmental biology and molecular biology for qualitatively assessing or quantitatively measuring the presence or amount, or the functional activity of a target entity, particularly a molecular entity. The target entity is sometimes referred to as an analyte or the measurand or the target of the assay. In conducting an assay, the target entity within a medium, such as a fluid medium, often needs to be accumulated and separated from other fluid components such that the target entity can be further analyzed with sufficient detection sensitivity. The further analysis of the separated target entity can represent conventional medical assay techniques or analyses based upon nanotechnology.

In various embodiments, suitable filter membranes can be inserted into or attached to a syringe using a connection mechanism, which can allow filter membranes of various suitable sizes to be attached to the syringe. Suitable connection mechanisms will be familiar to one having ordinary skill in the art. In some embodiments, suitable connection mechanisms can include a luer lock fitting. Other friction or compression fit connections can also be suitable for practicing the embodiments described herein, for example.

Moreover, although certain embodiments described herein are illustrated in reference to a syringe for withdrawing and dispensing a fluid and separating target entities therein, optionally followed by analysis thereof, it is to be recognized that any device capable of withdrawing and/or dispensing a fluid can be used in the embodiments described herein. In the syringe realm, withdrawal and/or dispensation of a fluid, for example, can be conducted without using a needle. Similarly, other suitable withdrawal and dispensation devices can function similarly to a syringe but without directly resembling a standard hypodermic syringe configuration, such as an IV bag or similar fluid infusion pump. For simplicity, the description herein will be presented in reference to a syringe, since standard syringes are commonly used in the medical field and represent an inexpensive approach for practicing the various embodiments described herein.

Further, although the description herein is primarily directed to perforated graphene, it is to be recognized that other two-dimensional materials or near two-dimensional materials can be treated in a like manner. That is, filter membranes containing other perforated two-dimensional materials can be used in a similar manner in conjunction with the embodiments described herein.

In the embodiments described herein, one or more filter membranes containing graphene and/or another two-dimensional material can be stacked upon one another. In some embodiments, connections between the filter membranes can be made via a standard fitting, such as a luer lock fitting on a housing in which the filter membrane is held. The filter membranes can include a single sheet of perforated graphene or other two-dimensional material, or multiple sheets (up to about 20 sheets). When multiple sheets are present, the perforation size (effective pore size) within each sheet can be the same or different, which can allow the interlayer flow to be altered. Moreover, the perforation size within each filter membrane can also the same or different as described hereinafter. In some embodiments, the filter membranes can be disposed perpendicular to a fluid flow pathway (i.e., the fluid flow passes through a needle into the filter membranes and then into the syringe body). In alternative embodiments, cross-flow filtration configurations can be used. Cross-flow can also be used for purging or flushing of perpendicular disposed filter membranes.

In some embodiments, the graphene or other two-dimensional material can be functionalized. Particularly, the perimeter of the apertures within the graphene can be functionalized. Suitable techniques for functionalizing graphene will be familiar to one having ordinary skill in the art. Moreover, given the benefit of the present disclosure and an understanding consistent with one having ordinary skill in the art, a skilled artisan will be able to choose a suitable functionality for producing a desired interaction with a target entity in a fluid, such as a biological fluid. For example, the apertures in a graphene can be functionalized such that they interact preferentially with a protein or class of proteins in deference to other biological entities of similar size, thereby allowing separations based upon chemical characteristics to take place. Thus, a target entity can be captured within the filter membrane for further analysis, if desired, optionally by functionalizing the membrane material. In some embodiments, the methods described herein can further include releasing the target entity or a signaling entity from the membrane material in order for analysis to take place. In other various embodiments, analysis can take place while the target entity is disposed on the filter membrane.

In some embodiments, the graphene or other two-dimensional material can be functionalized with a chemical entity so that the functionalization interacts preferentially with a particular type of biological target entity (e.g., by a chemical interaction). In some or other embodiments, the graphene or other two-dimensional material can be functionalized such that it interacts electronically with a biological target entity (e.g., by a preferential electrostatic interaction). Graphene or other two-dimensional material may be treated with certain functionalization so as to repel/impede or attract/facilitate passage of components contained within a fluid, for example, allowing or facilitating certain components to pass through the membrane while repelling or impeding passage of undesired components. For example, pores functionalized with negatively charged moieties such as carboxylate groups (—COO—) can repel or impede species that are positively charged (cationic). Alternatively, pores functionalized with positively charged species, such as protonated amine groups, can repel or impede species that are negatively charged (anionic).

In some embodiments, the graphene or other two-dimensional material can be mounted on a porous substrate to provide among other benefits mechanical support. The porous substrate has pores large enough to allow passage of any entities that are intended to be separated in the filter device. In an embodiment, a step of pre-filtration of the fluid that is to be passaged through the filter device is undertaken to remove large particulate material. It will be appreciated that pre-filtration should be selected to avoid removal of target entitles. In an embodiment, a fluid that has been passaged through the filtration device may be subjected to one or more additional filtration step thereafter. The one or more additional filtration steps may be accomplished using a similar filtration device configuration or a different filtration device configuration. For example, a fluid passaged through a filtration device of the invention maybe subsequently passaged through a sterilization filter (as are known in the art) to ensure elimination/exclusion of undesired microorganisms.

In some embodiments, the graphene or other two-dimensional material can be mounted on a substrate that facilitates detection, not just sequestration of a particular target entity. Suitable substrates for facilitating detection can encompass those providing for visible, colorimetric, fluorescent, UV-VIS or other confirmation and quantification of binding of specific target entities thereon, particularly those that have a size above the perforation size of the graphene. Activation of the assay for such detection mechanisms can take place by any number of factors such as, for example, time, temperature, electrical activation, and the like. For example, electrical power (e.g., supplied by a battery) can be used to lyse cells to release molecules, modify a functionalization to release a dye molecule or other signaling entity which can be indicative of binding, or to simply facilitate binding to the graphene. Release of dye molecules, for example, can be indicative of the presence or absence of a target entity on the graphene.

As described above, filter membranes configured for detection of target entities of variable size or chemical characteristics can be stacked upon one other, where a flow pathway through the filter membranes progresses from the largest effective pore size to the smallest effective pore size. For example, in a non-limiting embodiment, filter membranes configured for retaining and assaying a subject's blood for bacteria (e.g., e coli), viruses (e.g., hepatitis or HIV), and radioisotopes or heavy metals can be disposed in series with one another, as depicted in FIG. 8. Other biological entities such as antibodies and the like can also be separated and analyzed in a similar manner.

In some embodiments, a fluid containing target entities to be analyzed can be drawn into a syringe to which is attached a plurality of filter membranes, where an effective pore size of the filter membranes progresses from largest to smallest. For example, a needle can be attached to the filter membrane having the largest effective pore size and the syringe can be attached to the filter membrane having the smallest effective pore size. Target entities trapped within the filter membranes can then undergo further analysis, as described hereinafter, or the fluid in the syringe can be assayed. By separating the filter membranes from one another for analysis, the target entities trapped therein can be analyzed individually, thereby decreasing the opportunity for analytical interference.

In other embodiments, a fluid containing target entities to be analyzed can be drawn into a syringe or like fluid withdrawal device without first being filtered. Thereafter, a plurality of filter membranes can be attached to the syringe, where an effective pore size of the filter membranes progresses from largest to smallest and the filter membrane with the largest effective pore size is attached to the syringe. In alternative embodiments, the filter membranes can be initially connected to the syringe and connected to one another in the same order, but the filter membranes can be bypassed when initially drawing the fluid into the syringe. In either case, the fluid in the syringe can be passed through the filter membranes starting with the largest effective pore size and proceeding to the smallest effective pore size. As before, the trapped target entities can then undergo further analysis.

Regardless of how the target entities become sequestered on the various filter membranes, the target entities can then be assayed according to the embodiments described herein. Assays can take place using common assay techniques that will be familiar to one having ordinary skill in the art, such as assays common in the scientific literature and routinely practiced in the laboratory. In this regard, the assay can be activated by time, temperature, electrical or other activation mechanism, as further described above. In some embodiments, this feature can result in fixing/electrically immobilizing the graphene or the substrate to result in separation of the various sections. Assays of the separated target entities can then be conducted through any suitable analysis technique, including those based upon nanotechnology.

Thus, the embodiments described herein provide a kit that represents a modular test that can be disposable and provide easy to read results, with the opportunity for various levels of customization and modification to suit a particular testing application.

In addition, the filter membranes described herein can be used to further improve patient safety. For example, the filter membranes can be used to remove viruses, bacteria or other pathogens from a fluid being administered to a patient, so as to prevent the spread of disease. Although a syringe can be used for administering a fluid to a patient, it is to be recognized that other dispensation devices can also be used similarly, such as IV bags, infusion pumps, and the like.

The embodiments described herein will now be presented with further reference to the drawings.

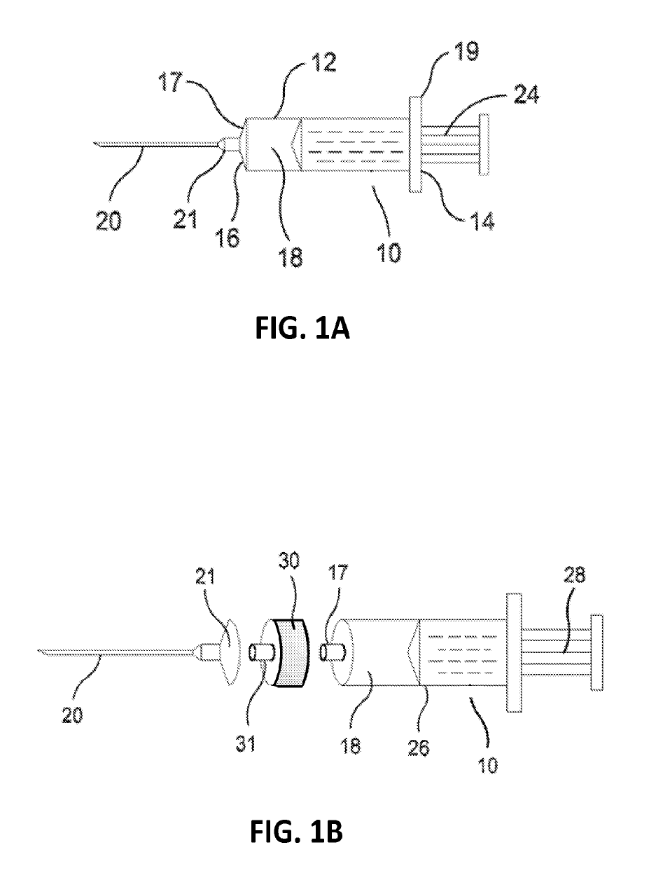

FIG. 1A shows an illustrative schematic of a syringe (10) containing a standard interface to which a filter membrane can be attached for example, within a filter module (30). The syringe includes a needle (20) shown as attached to the syringe. FIG. 1B shows an illustrative schematic of a syringe having a removable filter membrane containing a perforated two-dimensional material attached thereto, as illustrated within a filter module (30). Referring now to FIG. 1A and FIG. 1B, a syringe useful in the present invention is designated generally numeral 10. The syringe (10) has a barrel (12) which is of a tubular construction. The barrel (12) has a plunger end (14) that is opposite a needle end (16). The barrel (12) provides an open interior 18. Extending radially from the plunger end (14) is a flange (19) to facilitate manual operation of the plunger (24). Hub (17) provides for connection to the needle (20) which connection can be made by various standard connection interfaces (21), including a luer lock connection. The plunger (24) is slidably received in the barrel (12). The plunger (24) includes a plunger tip (26) at one end which has an outer diameter sized to allow slidable movement within the interior (18). As will appreciates it in the art, the plunger tip (26) is sized to create enough of a seal to preclude migration of material from within the interior (18) while also generating a suction force at the needle end (16) when the plunger is pulled. Opposite the plunger tip (26) is a push end (28). It will be appreciated that the push end (28) may be manipulated by a user, or an automated mechanism or the like to move the plunger in a desired direction. Suction mechanisms other than a plunger within a barrel may be utilized to pull or draw material through filter modules or filter membranes with pores as disclosed herein.

One or more filter modules (30) is maintained at the needle end (16) of the barrel (1). Hub 17 is connected to an end of the filter cartridge 30 opposite the needle end 16 of the barrel. The filter module is provides with connector 31 (which can be any standard interface that is fluid tight, such as a luer lock fitting. Filtration is accomplished in a syringe device as shown by operation of the plunger to draw fluid into a needle, through the filter module and into the barrel of the syringe. Alternatively, a fluid can be first drawn into the syringe barrel prior to attachment of the filter module, then the filter module can be attached and fluid cam be pushed through the filter module. The direction of fluid flow in these alternative modes of operation is in opposite directions so that the order of a plurality of filter modules for size-range separations is appropriately adjusted. In size-range separations, the filter membranes (and the filter modules containing them) are arranged in series with filter membrane pore size decreasing in the direction of fluid flow.

As will be described in further detail, the filter module (30) may be moveable and/or replaceable so as to allow for retention of desired size components, such as molecules, or a size range of components, such as molecules. In the syringe embodiments herein, the syringe functions for fluid flow control through a filter module, filter modules in series or a filter device. It will be appreciated that the one or more filter modules of this invention can be implemented in with a variety of filter flow control devices, for example one or more pumps with optional flow controls and appropriate fluid conduits can be provided to implement fluid flow control.

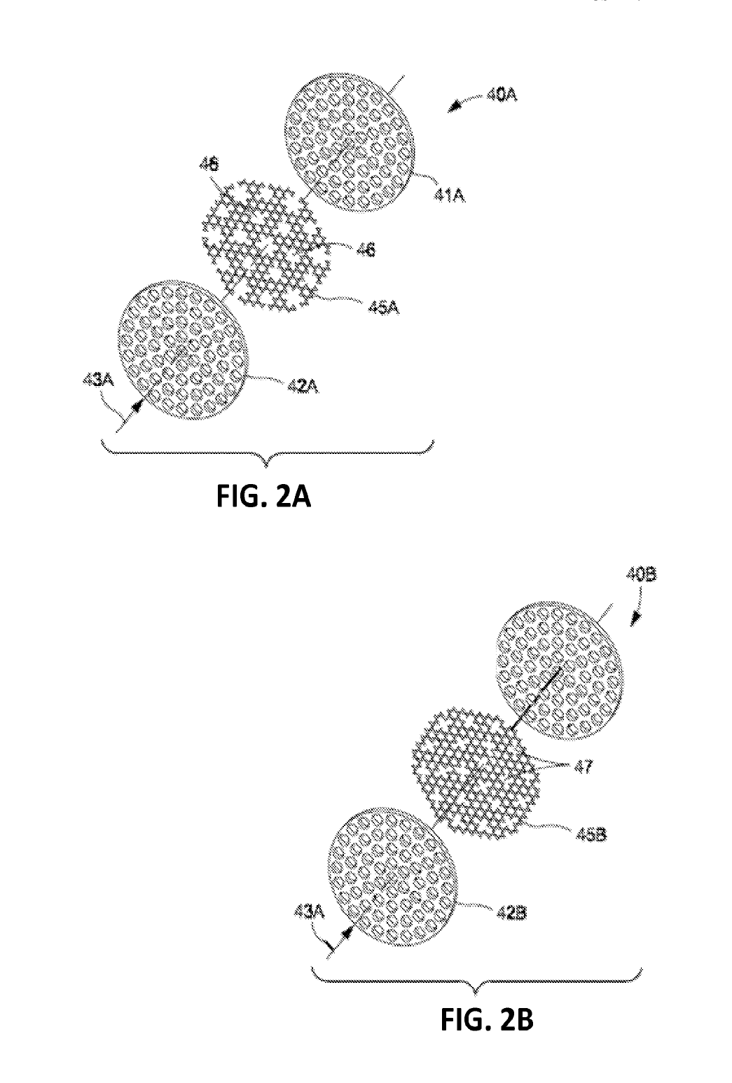

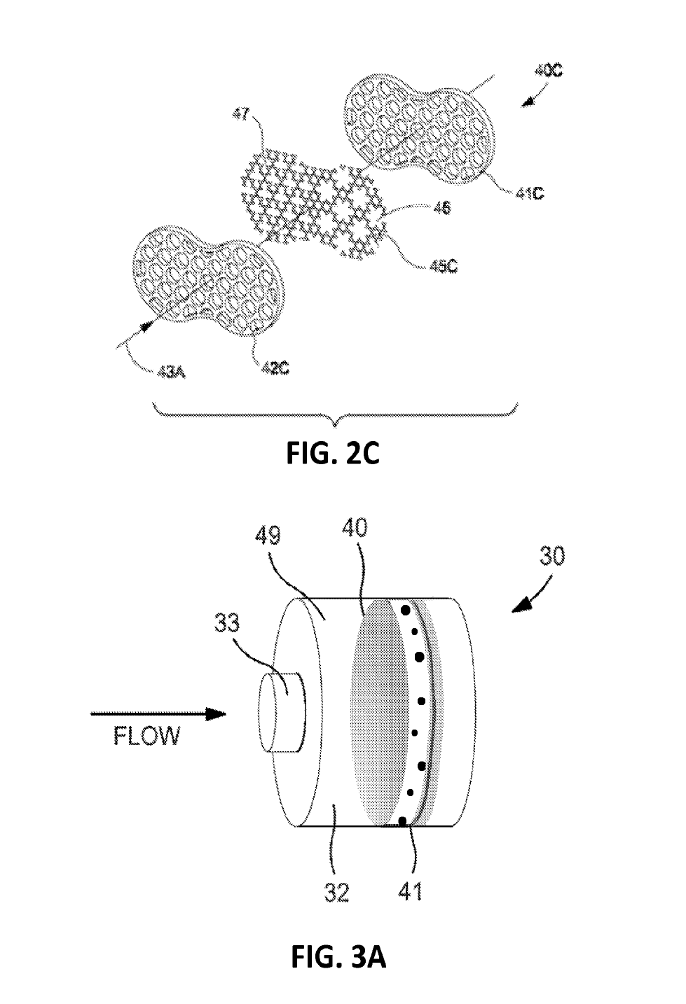

FIGS. 2A-2C show illustrative schematics of filter membranes (40-A-C) containing a perforated two-dimensional material (45A-C) disposed between two layers of a porous support (41A-C and 42 A-C). While illustrated in certain shapes, the filter membrane can be any shape. The direction of flow is shown as 43 A. Note that a single layer of support preferably (layer 41A-41C) may be employed.

The filter membrane in FIG. 2A has a two-dimensional material 45A which is perforated to have apertures or pores 46. The filter membrane in FIG. 2B has a two-dimensional material 45B which is perforated to have apertures or pores 47. The pores sizes of filter membranes in different modules are typically different and are selected to be different as discussed herein above. In the illustrated embodiments, of FIGS. 2A and 2B, pores 46 have effective pore size larger than the effective pore size of pores 47. Placing the filter membrane of FIG. 2A in series with that of FIG. 2B where the filter membrane of FIG. 2A is first and that of FIG. 2B is second in the direction of fluid flow will capture a size-range pool of entities between the pore size of pores 46 and the pore size of pores 47.

FIG. 2C illustrates a specific embodiment of a filter membrane useful in the invention the use of which has been described in International application PCT/US2015/18114, filed Feb. 27, 2015, which in turn claims the benefit of U.S. application Ser. No. 14/193,007, filed Feb. 28, 2014. These patent documents are incorporated by reference herein for description of this filter membrane. The filter membrane 45 C in this illustrated embodiment contains two portions: a portion where the pores 46 are larger than the pores 47 in the second portion. Such a filter membrane can be used in a filter module where in the filter membrane is mounted in a holder having a mechanical mechanism for switching the two portions of the filter membrane in and out of the fluid flow. Various such mechanisms are shown in the patent documents cited above.

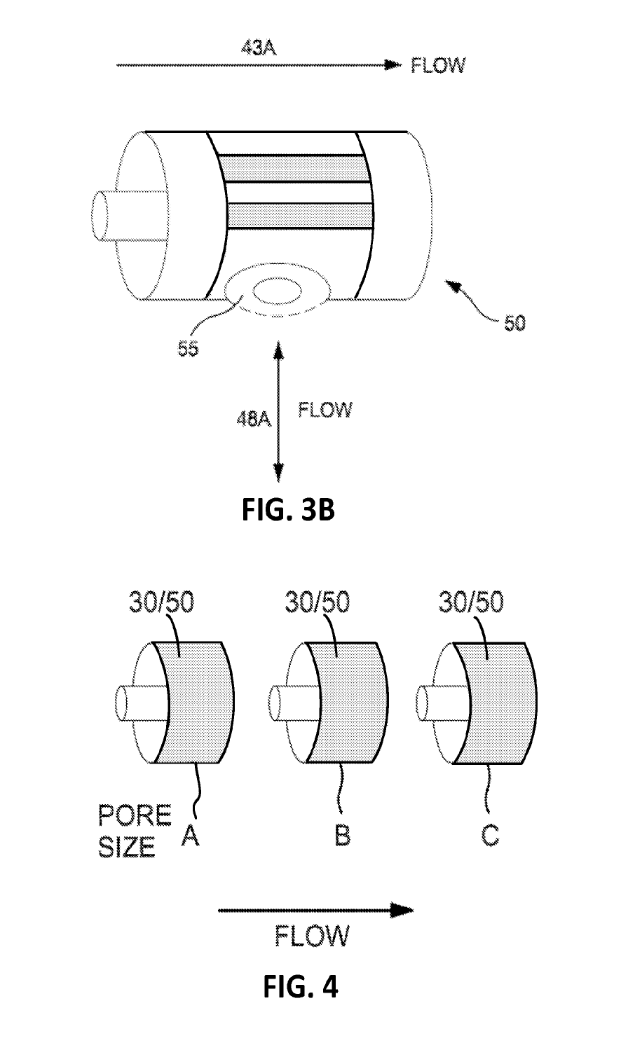

FIGS. 3A and 3B show illustrative schematics of a perforated graphene-based filter membrane (40) disposed in a luer-lock housing (32) having luer lock fitting (33). The luer lock fitting provides an exemplary inlet. The filter membrane (40) is shown as supported on a porous support layer (41). The module has a chamber 49 which encloses entitles sequestered on the filter membrane after filtration.

FIG. 3B illustrates alternative filter module having a side port (55) which can be used to access the chamber with the module. This side port can function as an optionally valved inlet or outlet and as such can also be used for introducing other components, such as buffers, or for cross-flow purging, for example. A plurality of such side ports can be provided in a given filter modules.

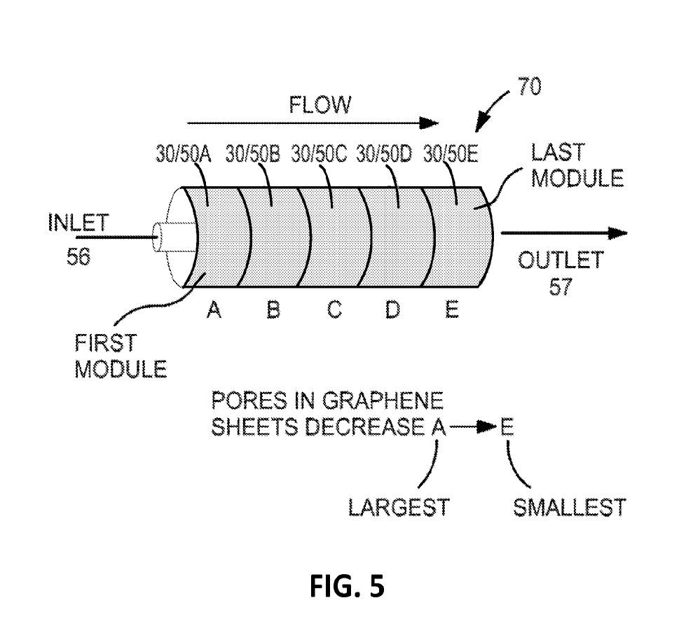

FIG. 4 shows an illustrative schematic of graphene-based filter modules (30/50) each carrying a filter membrane disposed in series, where the pore size can be the same or different. In a specific embodiment, the pore size of the modules in series decreases in the direction of flow through the filter modules. In the illustrated flow direction, in this embodiment, pores size A is larger than pores B is larger than pore size C. The plurality of filter modules shown can be implemented in a filter device wherein the modules are interfaced one with the other via a fluid tight sealing mechanism. Such a filter device can further be provided with any of various optionally valves inlets and outlets to facilitate fluid flow through the filter. A plurality of filter modules can be implemented in a filter device employing a syringe to provide for fluid flow. FIG. 5 shows an illustrative schematic of a plurality of filter membranes (30/50) arranged in series with a first and a last module and intervening modules (30/50A-E), where the effective pore size decreases in the direction of intended fluid flow. In a specific embodiment, the first module can be provided with an optionally valved inlet (56) and the last module in series can be provided with an optionally valved outlet (57). This configuration provides a filter device 70.

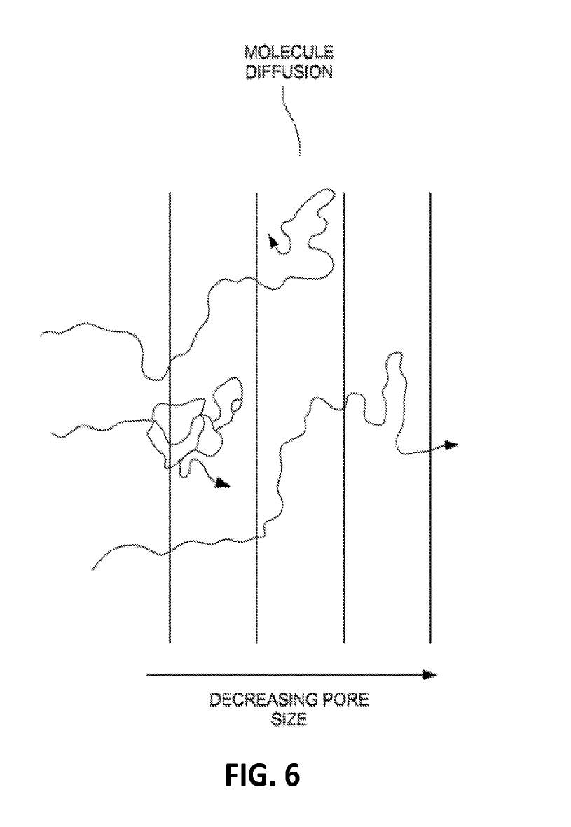

FIG. 6 shows a schematic illustrating the effect of decreasing pore size, where progressively smaller molecular entities are occluded within the filter.

In some embodiments, binding of the target entities to the filter membrane can result in release of a dye or like signaling entity that can be detected to indicate the presence, absence or saturation of the target entity on the filter membrane. In some embodiments, the dye can be released during a further stimulation event of the filter membrane, as discussed hereinafter and elsewhere herein. In some or other embodiments, the occlusion of target entities by the filter membrane can permit Forster resonance energy transfer analyses to be conducted. As one of ordinary skill in the art will recognize, such measurements are based upon the distance between a fluorescent molecule and a quencher. Thus, by measuring fluorescence, the presence or absence of a target entity can be determined. Other suitable analysis techniques for assaying for the target entities on the filter membrane can also be envisioned.

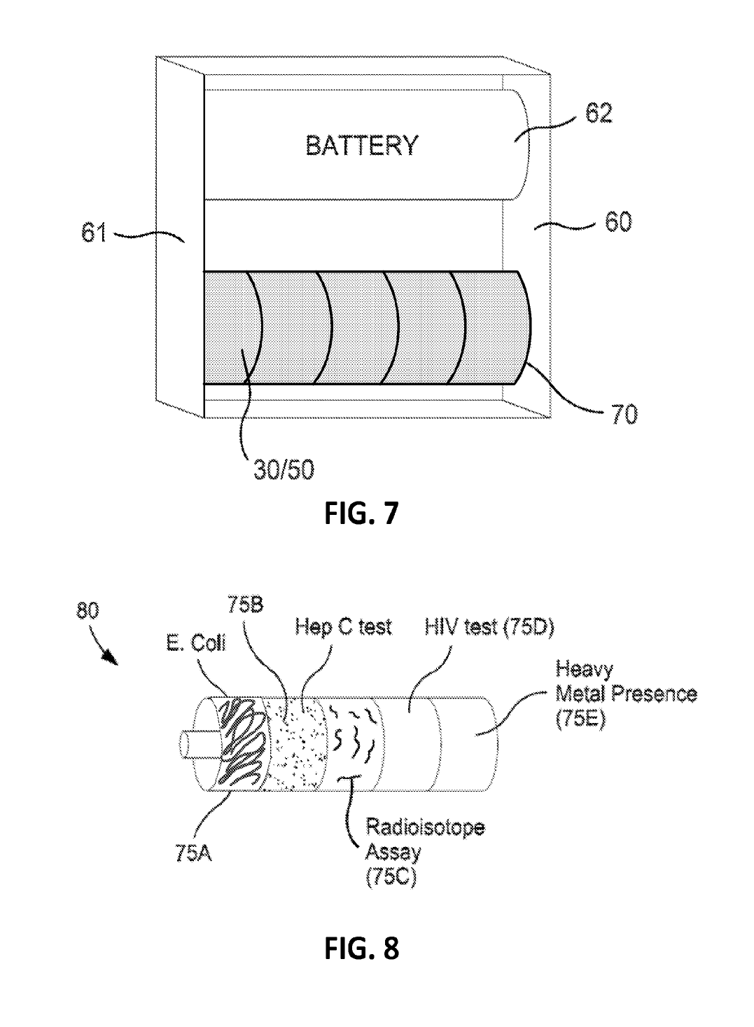

FIG. 7 shows an illustrative schematic wherein the filter membrane configuration of FIG. 5 can be stimulated by an electrical current to promote release and/or analysis of the target entities housed therein. Optional spacers (60 and 61) can be used to facilitate connection of a battery (62) to the filter device 70 which is composed of a plurality of filter modules (30/50). As discussed above, electrical stimulation is but one technique whereby further assay of the target entities may take place. Other sources of electrical power can be envisioned, such as a direct electrical connection to an AC or DC power source, a generator, a hand cranked generator, or the like. In illustrative embodiments, application of voltage can result in cell lysing to release molecules, modify the filter membranes to release the target entities or a dye/visualization molecule, or fix/immobilize/seal the graphene to make the filter membranes separable from one another. The simultaneous detection and analyses offered by the configurations of FIGS. 5 and 7 are believed to represent particular advantages in analyzing the complex mixtures that can often be present in biological media.

FIG. 8 shows an illustrative schematic of a series of filter modules stacked together forming a filter device 80. The filter module configuration is illustrated to sequester biological entities of different effective sizes and filter membrane pore size decreases in the direction of flow. Module 75A sequesters biological cells such as Escherichia coli (alternatively mammalian cells, including tumor cells might be sequestered). Modules 75B-75 C is illustrated to sequester varying sizes of viruses/or biological polymers such as proteins Module 75E is illustrated to sequester small molecules, atoms or ions, such as heavy metal atoms or ions. FIG. 8 also illustrates that the type of assay that may be performed can be selected as appropriate for the size and type of species sequestered in a given module. The assays noted in FIG. 8 are illustrative. For example, cells sequestered in module 75A can be removed from the module and identified by standard methods. Alternatively, cell captures in module 75A can be lysed (chemically or via application of electrical current) to collect nucleic acids or other biological polymers which can be assayed by well-known methods. For nucleic acids hybridization assays or PCR (polymerase chain reaction) methods can be employed to identify the cells that have been captured. It is noted that an intermediate step of culturing of the cells capture may be applied to facilitate identification of captured cells.

In a specific embodiment, cell can be captures on a first filter module and the captures cells lysed, for example by application of electric current to the filter membrane. The lysate of the cells can then be flushed with application of a carrier fluid to another filter modules or series of filter modules to perform size-range separation on the cell lysate. Various known assays can be performed on size-range selected lysate components, such as radioisotope assays, chemical assays, ligand binding assays and the like.

Various assays for the presence of viruses can be applied if desired (HIV test, Hep C test). Various tests for the presence of a selected protein can be applied, for example, selective antibody assays for a given protein. A radioisotope assay may be employed on fluid samples which contain components which are enriched in such isotopes or where one or more selected components are treated to contain certain radioisotopes.

In a specific embodiment, a series of colorimetric assay are performed on the entities captures in the different modules and the results of any color change can be observed by observing a color change in the module or on a given filter membrane. In an embodiment, the housings of the filter modules are transparent to allow observation of such color change. In another embodiment, one or more assays that effect a change in fluorescence are employed and the change in fluorescence in the module or on the filter membrane can be observed or detected by methods that are known in the art. In another embodiment, the filter device is configured such that entities capture within the module on the filter membrane of released form the filter membrane can be assayed by irradiation with light, e.g., UV-VIS spectroscopy.

The filter device of the invention can be implemented in a kit providing a plurality of filter modules, with filters of selected sized for construction of a filter device for separation of selected size-ranges of entities. For example, a kit can provide a set of filter modules having pore sizes A1-A20, where A1 is the largest pore size and A20 is the smallest pore size. The pore sizes of the filter modules can be selected to cover a desired range of sizes, for example from one to 1000 nm and the pore sizes of modules can be set at intermediate pore sizes in this range (e.g., A20 at 50 nm, A19 at 100 nm, A18 at 150 nm . . . A1 at 1000 nm) and two or more of the filter modules can be arranged in decreasing size order to form a selected filter device to provide desired size range pools (e.g., A20, A15, A10, A5, A1 in series; or A18, A7, A5, A2, A1 in series.) It will be appreciated that various combinations of filter modules can be combined to achieved desired size-range separations.

With respect to application of electric current to a given filter module. A filter membrane can be provided with electrodes for application of such current. Various means for application of current and fashioning of appropriate electrodes is known in the art. FIG. 7 illustrates application of a current to all of the filter modules. However, it will be appreciated that current can be applied to fewer than all filter modules. In this embodiment, it will be appreciated that filter modules to which current is to be applied must be electrically isolated from those filter modules to which current is not to be applied. Appropriate isolation methods and materials to achieve electrical isolation arte known in the art. When a conductive two-dimensional material is employed in the filter membrane, such as a graphene-based material or graphene, then electrical leads can be provided as appropriate to the filter membrane itself to supply current thereto.

Although the disclosure has been described with reference to the disclosed embodiments, one having ordinary skill in the art will readily appreciate that these are only illustrative of the disclosure. It should be understood that various modifications can be made without departing from the spirit of the disclosure. The disclosure can be modified to incorporate any number of variations, alterations, substitutions or equivalent arrangements not heretofore described, but which are commensurate with the spirit and scope of the disclosure. Additionally, while various embodiments of the invention have been described, it is to be understood that aspects of the disclosure may include only some of the described embodiments. Accordingly, the disclosure is not to be seen as limited by the foregoing description.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials and synthetic methods other than those specifically exemplified can be employed in the practice of the invention without resort to undue experimentation. All art-known functional equivalents, of any such methods, device elements, starting materials and synthetic methods are intended to be included in this invention. Whenever a range is given in the specification, for example, a temperature range, a time range, or a composition range, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The preceding definitions are provided to clarify their specific use in the context of the invention.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

1-35. (canceled)

36. A method comprising passing a fluid containing one or more target entities therein through at least two separation membranes, wherein
the separation membranes are arranged in series with one another, to thereby separate at least one target entity from said fluid;
the separation membranes each comprise a perforated two-dimensional material;
the separation membranes comprise pores with an effective pore size of from 0.5 nm to 1000 nm; and
at least one of the target entities is a biological molecule selected from the group consisting of proteins, antibodies, peptides, nucleic acids, and two or more thereof.

37. The method of claim 36, further comprising assaying for at least one target entity on one or more separation membranes.

38. The method of claim 36, further comprising modifying a target entity on one or more separation membranes and thereafter assaying for at least one product entity of said modification.

39. The method of claim 36, further comprising flushing one or more target entities sequestered on one or more separation membranes from the separation membrane by application of a cross flow of wash fluid.

40. A method comprising passing a fluid containing one or more target entities therein through at least two separation membranes,
wherein the separation membranes are arranged in series with one another, to thereby separate at least one target entity from said fluid, and the separation membranes each comprise a perforated two-dimensional material.

41. The method of claim 40, wherein the separation membranes comprise pores with an effective pore size that allows for separation of the at least one target entity.

42. The method of claim 40, further comprising assaying for at least one target entity on one or more separation membranes.

43. The method of claim 40, further comprising modifying a target entity on one or more separation membranes and thereafter assaying for at least one product entity of said modification.

44. The method of claim 40, wherein at least one of said target entities is a biological molecule.

45. The method of claim 40, wherein the biological molecule is selected from the group consisting of proteins, antibodies, peptides, nucleic acids, and two or more thereof.

46. The method of claim 40, further comprising a step of flushing one or more target entities sequestered on one or more separation membranes from the separation membrane by application of a cross flow of wash fluid.

47. The method of claim 41, wherein the at least one target entity comprises a biological substance.

48. The method of claim 40, wherein passing a fluid through the separation membranes comprises drawing a fluid through the separation membranes by application of suction or a vacuum.

49. The method of claim 40, wherein passing a fluid through the separation membranes comprises employing a pump to control fluid flow through the separation membranes.

50. The method of claim 40, wherein passing a fluid through the separation membranes comprises drawing a fluid into a syringe.

51. The method of claim 40, wherein passing a fluid through the membranes comprises drawing a fluid into a syringe and then dispensing the fluid through the separation membranes.

52. The method of claim 40, further comprising releasing a component from at least a portion of at least one separation membrane in conjunction with assaying.

53. The method of claim 40, wherein the two-dimensional material comprises perforated graphene based material.

54. The method of claim 40, wherein the two-dimensional material comprises perforated graphene.

55. The method of claim 42, wherein the two-dimensional material comprises perforated graphene-based material.

56. The method of claim 42, wherein the two-dimensional material comprises perforated graphene.

57. The method of claim 40, wherein the separation membranes comprise pores with an effective pore size of from 0.5 nm to 1000 nm.

58. A method comprising administering a fluid to a patient after passing the fluid through at least one separation membrane, the at least one separation membrane removing at least one biological molecule or toxin from the fluid, wherein the at least one separation membrane comprises a perforated two-dimensional material.

59. The method of claim 58, wherein two or more separation membranes are provided.

60. A filter device which comprises more than two separation membranes disposed in series with one another, the separation membranes each comprising a perforated two-dimensional material, and the separation membranes having pores with an effective pore size to allow for separation of fluid components.

61. The filter device of claim 60 comprising a plurality of filter modules disposed in fluid communication and in series with one another along a direction of intended fluid flow wherein each filter module comprises a perforated two-dimensional material and a filter housing for holding the perforated two-dimensional material in place.

62. The filter device of claim 60, wherein at least one filter module further comprises an access port providing access to entities collected on the separation membrane said access port positioned such that it is not in the intended direction of fluid flow.

63. The filter device of claim 60, wherein at least one filter module further comprises a chamber formed adjacent to the separation membrane and in which entities collected on the separation membrane are enclosed.

64. The filter device of claim 60, wherein at least one filter module further comprises a chamber formed adjacent to the separation membrane and in which entities collected on the separation membrane of the filter module are enclosed and wherein the chamber comprises an optionally valved cross-flow inlet.

65. The filter device of claim 60, wherein at least one filter module further comprises a chamber formed adjacent to the separation membrane and in which entities collected on the separation membrane of the filter module are enclosed and wherein the chamber comprises an optionally valved cross-flow outlet.

66. The filter device of claim 60, wherein at least one filter module further comprises a chamber formed adjacent to the separation membrane and in which entities collected on the separation membrane of the filter module are enclosed and wherein the chamber comprises an optionally valved cross-flow outlet and an optionally valved outlet.

67. The filter device of claim 60, wherein at least one filter module further comprises electrical connection for selective application of an electric current to the separation membrane therein.

68. The filter device of claim 60, wherein the effective pore size of the separation membranes range in size from 0.5 nm to 1000 nm.

69. The filter device of claim 60, wherein the separation membrane comprises perforated graphene-based material.

70. The filter device of claim 60, wherein the separation membrane comprises perforated graphene.

71. The filter device of claim 60, further comprising an inlet for receiving fluid flow in the intended direction.

72. The filter device of claim 60, further comprising a luer lock fitting as an inlet for fluid flow in the intended direction.

73. The filter device of claim 60, further comprising a fluid outlet and optionally a reservoir for receiving fluid after passage through the filter modules.

74. The filter device of claim 60, further comprising a fluid outlet and reservoir which is a syringe barrel.
